(19) United States
(12) Patent Application Publication
(10) Pub. No.: US 2016/0019552 A1
(43) Pub. Date: Jan. 21, 2016

(54) SYSTEM AND METHOD FOR USING SOCIAL MEDIA INFORMATION TO IDENTIFY AND CLASSIFY USERS

(71) Applicant: Capital One Financial Corporation, McLean, VA (US)

(72) Inventor: Dwij TRIVEDI, North Bethesda, MD (US)

(21) Appl. No.: 14/801,263

(22) Filed: Jul. 16, 2015

Related U.S. Application Data
(60) Provisional application No. 62/025,062, filed on Jul. 16, 2014.

(51) Int. Cl. G06Q 30/00; G06F 17/30; G06Q 50/00

(52) U.S. Cl. CPC G06Q 30/016; G06Q 50/01; G06F 17/30342

(57) ABSTRACT

Systems and methods include an application programming interface that enables a service provider system to interact with a social media system, a database associated with the customer service provider system, an empathy processor that transmits a request for empathy data to the social media system via a network using the application programming interface, wherein the request includes one or more keywords, and receives one or more empathy data segments from the social media system, wherein each of the one or more empathy data segments are associated with a user, a rules processor that evaluates the one or more empathy data segments based on a plurality of criteria, identifies the respective user associated with each of the one or more empathy data segments, and stores this classification in the database, and an alert processor associated with the customer service system that generates an alert based on the classification of the user.

### RELATED APPLICATIONS

The present application contains subject matter related to and claims the benefit of U.S. Provisional Patent Application No. 62/025,062, filed on Jul. 16, 2014, the contents of which is incorporated herein by reference in its entirety

The present application contains subject matter related to U.S. patent application Ser. No. 14/031,263 entitled “System and Method for Determining Social Statements,” U.S. Provisional Patent Application No. 61/914,719 entitled “System and Method for Financial Transfers from a Financial Account Using Social Media,” U.S. Provisional Patent Application No. 61/737,399 entitled “System and Method for Synching a Financial Account with a Social Network Account,” and U.S. Provisional Patent Application No. 62/003,171 entitled “System and Method for Providing Enhanced Financial Services Based on Social Signals,” the contents of which are incorporated by reference in their entirety.

### FIELD OF THE DISCLOSURE

The present disclosure relates to systems and methods for using social media information, including social empathy data, to identify and/or classify one or more users based on social empathy data.

### BACKGROUND OF THE DISCLOSURE

Currently, customer empathy and “pain points” are derived from user interviews, market research, listening in on customer calls etc. It is a lengthy, time consuming and potentially expensive process. Also, it is not possible know the relevant information of the person to determine whether they belong to the right segment (e.g., whether the person is a regular customer or user of the products and services provided). Customer pain points are not always easy to find at scale. Gathering empathy data from current channels also does not provide scale and broad reach including pain points that customers may be complaining about that are relevant to an institution's products and services.

These and other drawbacks exist.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts a schematic diagram of a system for classifying one or more users based on empathy data, according to an example embodiment of the disclosure;

FIG. 2 depicts a schematic diagram of a system for classifying one or more users based on empathy data, according to an example embodiment of the disclosure;

FIGS. 3A-3B depicts empathy data received by an empathy processor, according to an example embodiment of the disclosure; and

FIG. 4 depicts a schematic diagram of a method for classifying one or more users based on empathy data, according to an example embodiment of the disclosure;

### DETAILED DESCRIPTION OF THE EMBODIMENTS

The following description is intended to convey a thorough understanding of the embodiments described by providing a number of specific exemplary embodiments and details involving systems and methods for using social media information, including social empathy data, to identify and/or classify users based on empathy data appearing on, for example, the Internet. As used herein, the term “empathy data” may refer to data associated with and/or extracted and/or received from an individual's social networking profiles. Empathy data may indicate one or more “pain points” that the individual is experiencing relating to a product or service and have chosen to share with others by posting it to a social media site. For example, a user may tweet a complaint about the quality of customer service at a financial institution. The financial institution may extract the empathy data from the tweet to detect the user's dissatisfaction with the financial institution's services. The financial institution may gather additional data about the user from the social networking profile and/or other sources. The data may include age, location, gender, customer/prospect, products they are using, digital sentiment, interests, any brand affinity, life events, interaction with friends, etc. The financial institution may classify the user as an “extreme user” based on one or more criteria and use the classification to better serve the user and respond to his or her needs.

The various embodiments are made possible by social media interactions of social media users. Because social media enables users to publicize respective thoughts and expressions in a seemingly anonymous manner, services providers can monitor these thoughts and expressions in accordance with the various embodiments described herein. Indeed, these various embodiments solve the technical problem of identifying and/or classifying various social media users to determine whether a service provider can provide services to an account holder, for example, that publicizes thoughts and expressions in a seemingly anonymous manner.

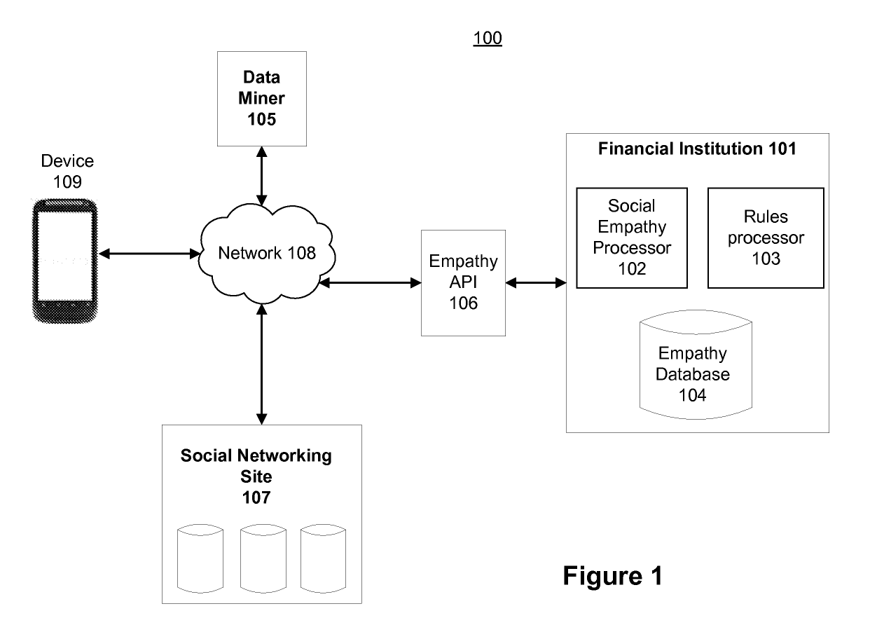

FIG. 1 depicts an exemplary embodiment of a system for receiving empathy data related to individuals and identifying and/or classifying those individuals based on the empathy data. The system may include various network-enabled computer systems, including, as depicted in FIG. 1 for example, a financial institution 101, comprising a social empathy processor 102, a rules processor 103, and an empathy database 104; a data miner 105; an empathy application programming interface (API) 106; a social networking site 107; a network 108; and a user device 109. These elements may be included as separate processors or combined into a single processor or device having the multiple processors. As used herein, the term “module” may be understood to refer to computer executable software, firmware, hardware, or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

In the exemplary embodiment shown in FIG. 1, social empathy processor 102, rules processor 103, and empathy database 104 are disclosed as a part of financial institution 101. Elements 102, 103, and 104 also may be separate from financial institution 101. Also, one or more of elements 102, 103, and 104 may be integrated into social networking site 107. Financial institution 101, social empathy processor 102, rules processor 103, data miner 105, social networking site 107, and user device 109 may comprise one or more network-enabled computer systems. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network.

The components depicted in FIG. 1 may store information in various electronic storage media, such as, for example, empathy database 104. Electronic information, files, and documents may be stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

The components depicted in FIG. 1 may be coupled via one or more networks, such as, for example, network 108. Network 108 may be one or more of a wireless network, a wired network or any combination of wireless network and wired network. For example, network 108 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 108 may include, without limitation, telephone lines, fiber optics, IEEE Ethernet 902.3, a wide area network (“WAN”), a local area network (“LAN”), or a global network such as the Internet. Also network 108 may support an Internet network, a wireless communication network, a cellular network, or the like, or any combination thereof. Network 108 may further include one network, or any number of the exemplary types of networks mentioned above, operating as a stand-alone network or in cooperation with each other. Network 108 may utilize one or more protocols of one or more network elements to which they are communicatively coupled. Network 108 may translate to or from other protocols to one or more protocols of network devices. Although network 108 is depicted as a single network, it should be appreciated that according to one or more embodiments, network 108 may comprise a plurality of interconnected networks, such as, for example, the Internet, a service provider's network, a cable television network, corporate networks, and home networks.

In various exemplary embodiments, an account holder may be any individual or entity that desires to conduct a financial transaction using one or more accounts held at one or more financial institutions, such as financial institution 101. Also, an account holder may be a computer system associated with or operated by such an individual or entity. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, or mobile commerce account. Financial institution 101 may be, for example, a bank, other type of financial institution, including a credit card provider, for example, or any other entity that offers accounts to customers. An account may or may not have an associated card, such as, for example, a credit card for a credit account or a debit card for a debit account. The account card may be associated or affiliated with one or more social networking sites, such as a co-branded credit card.

As used herein, social networking site 107 may comprise a website, mobile application and/or the like that allows a user to create an account and provide user-specific information, including interests, and network with other users based on social connections. Examples of social networking sites may include, without limitation, Facebook, MySpace, Google+, LinkedIn, Twitter, Pintrest, Yelp, Foursquare, or the like. Social networking site 107 may maintain accounts holding social media data for an account holder, such as, for example, user name, user phone number, user address, user email address, user occupation, and/or user location information.

User device 109 may be any computer device, or communications device including, e.g., a server, a network appliance, a personal computer (PC), a workstation, a mobile device, a phone, a handheld PC, a personal digital assistant (PDA), a thin client, a tablet computer, a smartphone, a fat client, an Internet browser, or other device. Non-limiting examples of a smartphone include an iPhone or an Android-enabled phone. A mobile device also may be a tablet computer. Non-limiting examples of a tablet computer include an iPad, Kindle Fire, Playbook, Touchpad, and the like.

Social empathy processor 102 may request empathy data from data miner 105 and/or social networking site 107. Data miner 105 may be, for example, a third party service that mines social data from social networking site 107 for certain empathy keywords and certain industry keywords. As used herein, social data may include information and content posted by one or more users (such as the user of user device 109) to their social media accounts on social networking site 107. Social data may include comments, likes/dislikes, posts, tweets, pins, status updates, tags, captions, and other content, including, for example, implicit customer service requests, supplied by one or more users. A user of user device 109 may have one or more social media accounts with social networking site 107. The user may have one or more financial accounts with financial institution 101. The user of user device 109 may post a comment/tweet/status update/pin on his social media account expressing frustration, anger, impatience, or some other negative emotion based on a negative experience with financial institution 101 and/or another entity in the same industry as financial institution 101.

The empathy keywords may be supplied by social empathy processor 102. The empathy keywords may include terms and phrases that are associated with customer pain points and/or customer service related requests. A pain point may indicate the user's dissatisfaction with a product or service offered by financial institution 101. Empathy keywords may include terms or phrases that indicate, for example, a negative emotion and/or an implicit customer service inquiry. Industry keywords may also include terms or phrases related to financial institution 101 and/or the industry for financial institution 101. Non-limiting examples include “credit”, “card”, “ATM”, “fee”, “transaction”, “debit”, “bank”, “bill”, “account”, “loan”, etc. Data miner 105 may employ one or more natural language processing tools to search social data using the one or more empathy keywords and industry keywords. For example, a phrase such as, “I hate my credit card,” may include an empathy keyword (e.g., “hate”) and industry key words (e.g., “credit” and “card”). Data miner 105 may look apply certain thresholds (e.g., return empathy data with a minimum of three empathy keywords and one industry keyword, or return empathy data with at least two empathy keywords in the same sentence, or return empathy data with at least one empathy keyword and one industry keyword in the same sentence). Data miner 105 may purchase social data from social networking site 107. Data miner 105 may be utilize one or more data mining tools such as Radiant Six, Sprinkler, etc. In various embodiments, social empathy processor 102 may use proprietary data mining tools to search social data at social networking site using empathy API 106 and/or one or more application programming interfaces provided by social networking site 107.

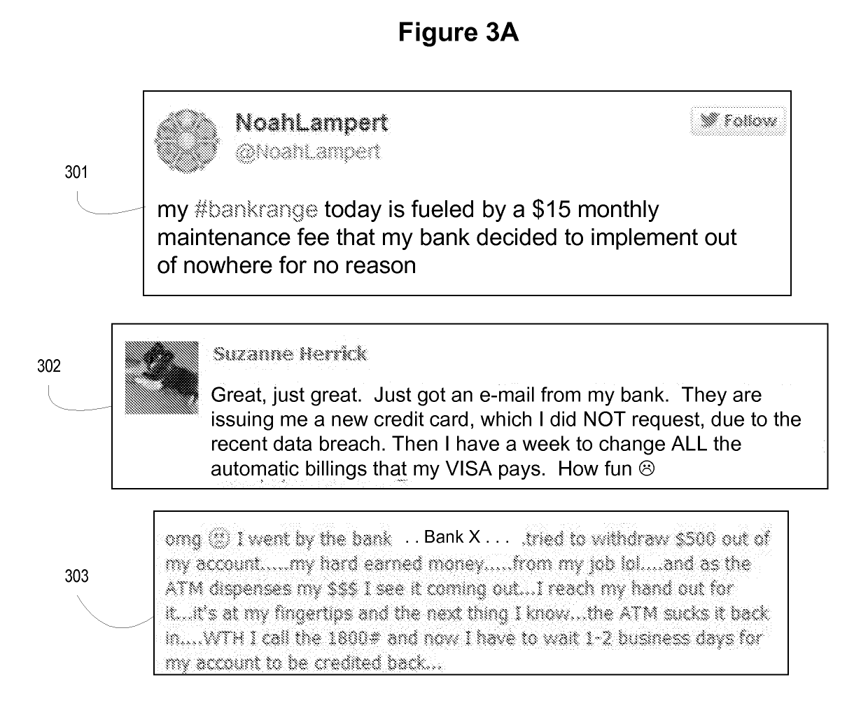

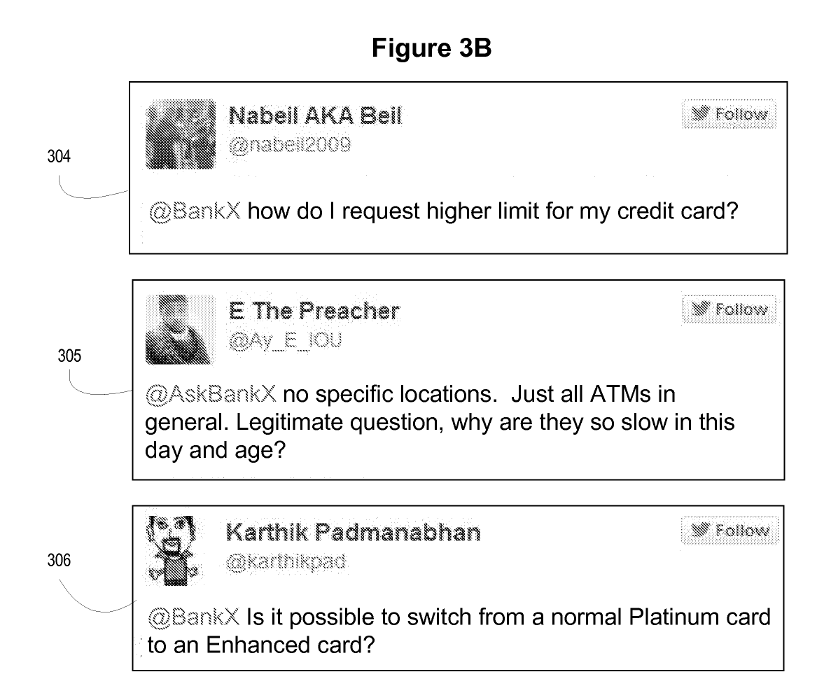

The data miner 105 may provide the empathy data to social empathy processor 102 via empathy API 106. Empathy data may be provided as one or more empathy data segments. Examples of empathy data segments are shown in, for example, FIGS. 3A and 3B. For example, in various embodiments, data miner 105 may provide empathy data segments 301-306 as shown in FIGS. 3A and 3B. Empathy data segment 301 may be a tweet from a user of social networking site 107. Segment 301 may include the username (@NoahLampert) of the individual that posted the social data. Segment 301 may include the body of the tweet. Social empathy processor 102 may have provided one or more empathy keywords to data miner 105, including “rage”. Social empathy processor 102 may have provided one or more industry keywords to date miner 105, including “fee”, “maintenance”, “bank”, and “monthly”. Data miner may have returned empathy data segment 301 based on the presence of one or more of the aforementioned keywords in the tweet.

Empathy data segment 302 may be a status update from a user of social networking site 107. Segment 302 may include the username (Suzanne Herrick). Segment 302 may include the body of the update. The empathy keywords in segment 302 may include negative emoticons, such as “ [symbol] ”. The empathy keywords may include phrases indicating sarcasm, such as “Great, just great.” The empathy keywords may include negative terms in all caps, such as “NOT”. Industry keywords in segment 302 may include “credit card”, “bank”, “billing”, “VISA”, and “pay”. Data miner 105 may have returned empathy data segment 302 based on the presence of one or more of the aforementioned keywords in the status update.

Empathy data segment 303 may be a comment from a user of social networking site 107. Segment 303 may include the username. Segment 303 may include the body of the comment. The empathy keywords in segment 303 may include negative emoticons, such as “ [symbol] ”. The empathy keywords may include abbreviations with negative connotations, such as “WTH”. Industry keywords in segment 303 may include “bank”, “withdraw”, “money”, “ATM”, “account”, “$500”, and “credited”. Data miner 105 may have returned empathy data segment 303 based on the presence of one or more of the aforementioned keywords in the comment. These keywords indicate the user who made this comment is experiencing one or more pain points with their bank. The keywords provided by social empathy processor 102 may include one or more business names associated with financial institution 101. Empathy segments 301-303 may include these one or more business names of financial institution 101. For example, comment 303 may include the name of financial institution 101 (“Bank X”).

Empathy data segments 304-306 may be returned, for example, because of the presence of the name of the financial institution 101 (“Bank X”). Empathy data segments 304-306 may be tweets that include the name of the user and the body of the tweet. Empathy data segments 304-306 may include questions directed at financial institution 101.

In various embodiments, social empathy processor may provide one or more “analogous empathy” keywords to data miner 105 and/or social networking site 107 to filter the social data. Analogous empathy keywords may include words and phrases that capture a user's negative emotional experience relating to one situation that is analogous to a second situation relevant to financial institution 101 and/or the industry for financial institution 101. For example, one or more users may post content to their social media accounts describing negative experiences associated with standing in line for a movie, a concert, a store opening, etc. This situation—standing in line—may be analogous to other situations where an individual may be required to stand in line—for example, at a bank location or an ATM. Social empathy processor 102 may provide analogous social empathy keywords including, without limitation, “line”, “stand”, “wait”, etc. Data miner 105 and/or social networking site 107 may return one or more empathy data segments based on the analogous empathy keywords.

Social empathy processor 102 may store the empathy data segments in empathy database 104 in a manner that associated the user with the empathy segment. Social empathy processor 102 may store the name of the user who created the empathy data segments in empathy database 104. Rules processor 103 may supply one or more extreme user criteria to social empathy processor 102 to evaluate each of the users with one or more empathy data segments. Extreme user criteria may be designed to evaluate whether the user who posted the empathy data segment is an extreme user of the products and services offered by financial institution 101 (or a competitor of financial institution 101). Rules processor 103 may first determine whether the user is an account holder with financial institution 101. Rules processor 103 may compare the name of the user (obtained from the social data) with names of customers of financial institution 101. If multiple matches are found, social empathy processor 102 may request additional social data from data miner 105 and/or social networking site 107. The additional social data may be the user's hometown, current location, age, gender, occupation, relationships, etc. Rules processor 103 may compare this additional data to account information for each match of the multiple matches. Rules processor 103 may use the results of this comparison to determine whether the user is an account holder with financial institution 101. If the user is an account holder, rules processor 103 may apply one or more of the following criteria to the account holder's account information.

The criteria may include a “digital maven” criteria. Digital maven criteria may evaluate whether the majority of the user's interactions with his financial account are done online. Rules processor 103 may determine whether the user has a banking application for accessing his account with financial institution 101. The rules processor 103 may compare the number of online interactions with the number of in-person interactions (where an in-person interaction may include a visit to an ATM and/or a visit to a physical location operated by financial institution 101). Rules processor 103 may classify the user as an extreme user if at least a majority of his banking interactions with his financial account are conducted online and/or using his banking application.

The criteria may include a “bill pay” criteria. Bill pay criteria may evaluate whether the user has a credit card account with financial account institution 101. If so, rules processor 103 may review the account information to determine whether the user has an automatic bill pay set up to pay one or more bills using the credit card account. If the user pays one or more bills using his or her credit card account, rules processor 103 may classify that user as an extreme user.

The criteria may include a “career path” criteria. Career path criteria may evaluate whether the user is on an aggressive career path. Rules processor 103 may evaluate the account information for the user to determine the user's income history. Rules processor 103 may evaluate how quickly the user's income has risen over a certain period of time. Rules processor 103 may evaluate the credit history of the user and other sources of information to determine the rate at which the user's income has increased. Other sources of information may include additional social data from social networking site 107. Rules processor 103 may compare the rate of increase to a predetermined rate (e.g., 20% a year). If the rate of increase is greater than the predetermined rate, rules processor 103 may classify the user as an extreme user.

Social empathy processor 102 may request additional empathy data for the user. Additional empathy data may include posts, comments, likes, tweets, tags, pins, and other content posted by the user to social networking site 107 in the past. Social empathy processor 102 may request this data from data miner 105 and/or social networking site 107. Social empathy processor 102 may include a timeframe for the request (e.g., the user's posts from the past 3 years). Social empathy processor 102 may provide empathy keywords and/or industry keywords to filter the social data. Social empathy processor 102 may receive the additional empathy data for the user and review it to determine whether the user has previously made negative and/or positive comments about his experience with products and services offered by financial institution 101 (and/or other entities in the same industry). Rules processor 103 may apply an “outspoken user” criteria to the returned empathy data. The outspoken user criteria may evaluate the number of times the user has posted content to his social networking site 107 that relates to financial institution 101. The outspoken user criteria may be a predetermined number of posts (e.g., 5 posts in the past year). If the number of empathy segments for the user exceeds the outspoken user criteria, the user may be identified and/or classified as an extreme user.

Some of the criteria applied by rules processor 103 may be independent of whether the user is an account holder with financial institution 101 (e.g., the career path criteria and the outspoken user criteria). Rules processor 103 may apply one or more of the criteria to the user to determine whether the user is an extreme user. Rules processor 103 may identified and/or classify the user as an extreme user if he meets at least half the criteria. Rules processor 103 may identified and/or classify the user as an extreme user if he meets at least one of the criteria. If the user is not an account holder with financial institution 101, rules processor 103 may identified and/or classify the user as an extreme user if he meets both the career path criteria and the outspoken user criteria.

Social empathy processor 102 may create an “empathy profile” of a user in empathy database 104. The empathy profile may include each of the empathy data segments in whole or in part associated with that user. The empathy profile may indicate which of the rules criteria the user met. The empathy profile may include information indicating whether the user was classified as an extreme user. If the user is an account holder, the empathy profile may be linked to the user's one or more financial accounts with financial institution 101.

Social empathy processor 102 may generate one or more messages and/or alerts for a user that has been classified as an extreme user. If the user is an account holder, social empathy processor 102 may transmit the alert/message to user device 109 (based on contact information previously provided by the user for his financial account). The alert/message may include a response to the empathy data segments. Social empathy processor 102 may send the alert/message to a customer service representative with financial institution 101. The response/alert may include the empathy data for the user, and instructions for contacting the user. The alert message may be a text message, SMS message, MMS message, in-app notification sent via a mobile banking app on user device 109, e-mail, message sent via social networking site 107, etc.

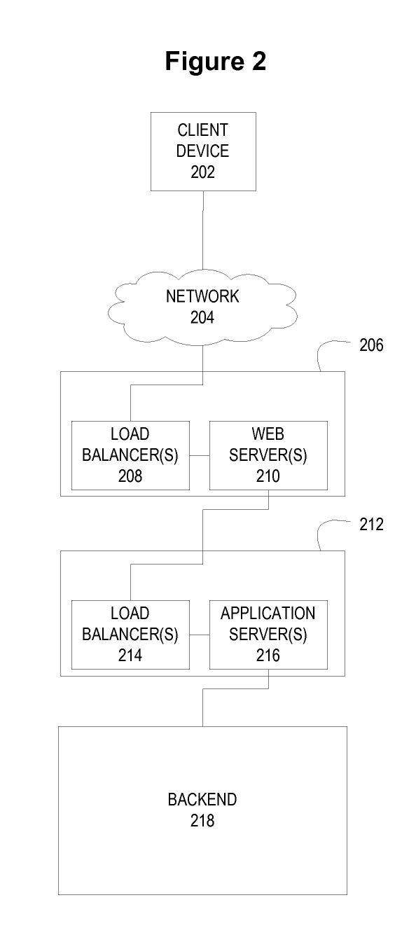

FIG. 2 depicts an example system 200 for classifying users based on social empathy data. As shown in FIG. 2, system 200 may include a client device 202, a network 204, a front-end controlled domain 206, a back-end controlled domain 212, and a backend 218. Front-end controlled domain 206 may include one or more load balancers 208 and one or more web servers 210. Back-end controlled domain 212 may include one or more load balancers 214 and one or more application servers 216.

Client device 202 may be a network-enabled computer. Client device 202 may be similar to buyer device 102a and/or seller device 102b. Client device 202 may be configured to execute one or more applications. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

Client device 202 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 204 may be one or more of a wireless network, a wired network, or any combination of a wireless network and a wired network. For example, network 204 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 204 may include, without limitation, telephone lines, fiber optics, IEEE Ethernet 902.3, a wide area network (WAN), a local area network (LAN) or a global network such as the Internet. Also, network 204 may support an Internet network, a wireless communication network, a cellular network, or the like, or any combination thereof. Network 204 may further include one network, or any number of example types of networks mentioned above, operating as a stand-alone network or in cooperation with each other. Network 204 may utilize one or more protocols of one or more network elements to which they are communicatively couples. Network 204 may translate to or from other protocols to one or more protocols of network devices. Although network 204 is depicted as a single network, it should be appreciated that according to one or more embodiments, network 204 may comprise a plurality of interconnected networks, such as, for example, the Internet, a service provider's network, a cable television network, corporate networks, and home networks.

Front-end controlled domain 206 may be implemented to provide security for backend 218. Load balancer(s) 208 may distribute workloads across multiple computing resources, such as, for example computers, a computer cluster, network links, central processing units or disk drives. In various embodiments, load balancer(s) 208 may distribute workloads across, for example, web server(S) 210 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 and 214 may include software that monitoring the port where external clients, such as, for example, client device 202, connect to access various services of a financial institution or third party (such as system 100 shown in FIG. 1), for example. Load balancer(s) 208 may forward requests to one of the application servers 216 and/or backend 218 servers, which may then reply to load balancer 208. This may allow load balancer(s) 208 to reply to client device 202 without client device 202 ever knowing about the internal separation of functions. It also may prevent client devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 208 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., client device 202) through a network (e.g., network 204), such as the Internet. In various examples, web servers, may deliver web pages, relating to, for example, online banking applications and the like, to clients (e.g., client device 202). Web server(s) 210 may use, for example, a hypertext transfer protocol (HTTP or sHTTP) to communicate with client device 202. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 210 may respond with the content of that resource or an error message if unable to do so. The resource may be, for example a file on stored on backend 218. Web server(s) 210 also may enable or facilitate receiving content from client device 202 so client device 202 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 216 may act as a set of components accessible to, for example, a financial institution or other entity implementing system 200 and/or system 100, through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 210 may behaves like an extended virtual machine for running applications, transparently handling connections to databases associated with backend 218 on one side, and, connections to the Web client (e.g., client device 202) on the other.

Backend 218 may include hardware and/or software that enables the backend services of, for example, a financial institution or other entity that maintains a distributes system similar to system 200 and/or system 100. For example, backend 218 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, system 100 (shown in FIG. 1) and the like. Backend 218 may be associated with various databases, including account databases that maintain, for example, customer account information, product databases that maintain information about products and services available to customers, content databases that store content associated with, for example, a financial institution, and the like. Backend 218 also may be associated with one or more servers that enable the various services provided by system 200. Backend 218 may be associated with one or more servers that enable the various services provided by system 100.

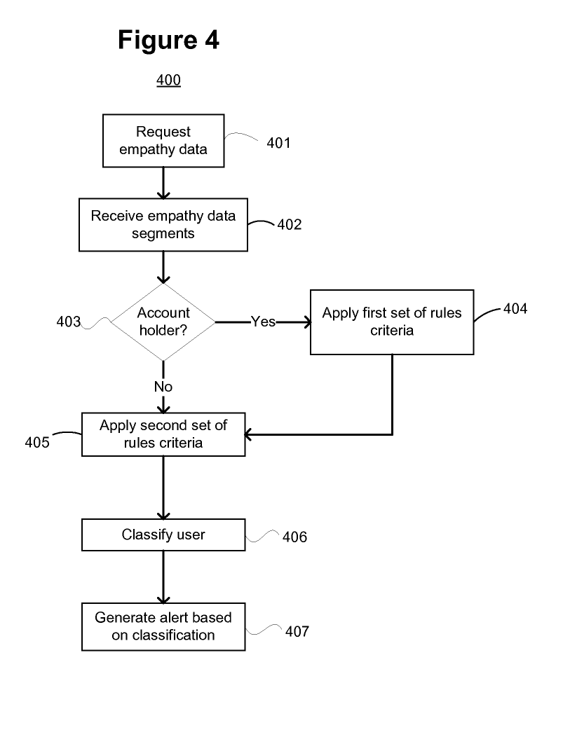

FIG. 4 is a flow chart illustrating a method for identifying and/or classifying one or more users based on empathy data. The method 400 shown in FIG. 4 can be executed or otherwise performed by one or more combinations of various systems. The method 400 as described below may be carried out by the system for classifying one or more users based on empathy data, as shown in FIGS. 1-3, by way of example, and various elements of that system are referenced in explaining the method of FIG. 4. Each block shown in FIG. 4 represents one or more processes, methods, or subroutines in the exemplary method 400. Referring to FIG. 4, the exemplary method 400 may begin at block 401.

At block 401, empathy data may be requested. The request may include empathy keywords and industry keywords. The request may be sent to a third-party data mining service and/or a social networking site. The third party data mining service and/or the social networking site may search social data using the empathy keywords and industry keywords. The social data may include content provided by users on their social media accounts. The social data may include posts, comments, likes & unlikes, tags, tweets, pins, and other content. In various embodiments, a financial institution may pull social data from a social networking site (e.g., using one or more application programming interfaces) and search the data itself using the empathy keywords and industry keywords. The empathy keywords and/or industry keywords may be structured to capture social data that reflects a user's negative experience (pain points) involving products and services offered by a company. Empathy keywords may include terms or phrases that indicate a negative emotion. Non-limiting examples include “angry”, “rage”, “wtf”, “wth”, “ [symbol] ”, “:-/”, “omg”, and variations of these. Industry keywords may also include terms or phrases related to financial institution 101 and/or the industry for financial institution 101. Empathy keywords also may include terms or phrases that are associated with an implicit customer service inquiry. Non-limiting examples include: “How do I . . . ,” “I need help with . . . ,” and/or the like. Non-limiting examples include “credit”, “card”, “ATM”, “fee”, “transaction”, “debit”, “bank”, “bill”, “account”, “loan”, “money”, “pay”, and variations of these. The request for empathy data may include a date range (e.g., search posts from the past month).

At block 402, method 400 empathy data segments may be received. Each empathy data segment may be a discrete piece of content from a user's social media account. The empathy data segment may include posts, comments, likes & unlikes, tags, tweets, pins, and other content. The empathy data segment may include the name and/or username of the user that posted the content. The empathy data segment may be received based on the results of one or more searches performed by the data mining service and or the social networking site using the empathy keywords and/or industry keywords provided in block 401. Examples of empathy data segments are shown in, for example, FIGS. 3A and 3B. Searches may look for social data where an empathy keyword is found in the same sentence as an industry keyword. Searches may look for social data where a minimum number of empathy keywords are found with a minimum number of industry keywords. For example, searches may look for social data having a minimum of 3 empathy keywords and at least one industry keyword in the same sentence as an empathy keyword. In one example, the empathy data may include the following post from a user's social media account: “My bank is the worst. I got hit with another $20 charge this month on a credit card that I haven't used since last year . . . WTF!?!?!?” This empathy data segment may be returned in response to a search that included industry keywords “bank”, “charge”, “month”, and “credit card”. The empathy keywords used may include “hit”, “worst”, and “WTF”. The search may also include restrictions looking for at least 3 industry keywords, and an empathy keyword in the same sentence as an industry keyword. In this example, “bank” and “worst” were in the same sentence, and the post included three industry keywords.

At block 403, for each empathy data segment, it may be determined whether the user is an account holder with the financial institution. While the embodiments in FIG. 1 are related to a financial institution, the disclosure may be applied to other entities in other industries and should not be limited to financial institutions. If the user is an account holder, method 400 may proceed to block 404. If the users is not an account holder, method 400 may proceed to block 405. In this example, the empathy data segment may have been from a tweet by John Doe, who has a credit card account with financial institution 101.

At block 404, a first set of criteria may be applied to the empathy data segment. The first set of criteria may be specific to account holders. The criteria may include digital maven criteria and/or bill pay criteria. The digital maven criteria may check whether the account holder does all of his banking interactions online. In this example, John Doe does all his banking for his credit card account on his mobile banking application. The bill pay criteria may check whether the account in question is used to pay one or more bills. In this example, the bill pay criteria may be met if the account is used to automatically pay at least two bills. Assume in this example that John Doe's credit card account is used to automatically pay his water bill, his phone bill, and his internet bill. Therefore, John Doe may meet both the digital maven criteria and the bill pay criteria.

At block 405, a second set of criteria may be applied to the empathy data segment. The second set of criteria may be for empathy data from users who are either account holder or non-account holders. The second set of criteria may include career path criteria and/or outspoken user criteria. Continuing with the previous example, John Doe may be working as a marketing representative at a mid-size company, and may not have been promoted in the past three years. The career path criteria may check the number of times the user has been promoted and/or changed jobs in a certain period of time. In this example, the career path criteria may only be triggered if the user has received at least job promotion in the past two years. This career data may be obtained from account information, credit reports, social media accounts, and other third party sources. Because John Doe has not been promoted, he does not meet the requirements for the career path criteria. The outspoken user criteria may be based on how many empathy data segments the user has posted in the past using his social media account (or accounts). The financial institution, data miner, and/or social networking site may search for other posts by the user in a certain timeframe using the empathy keywords and industry keywords. For example, the outspoken user criteria may be triggered if the user has posted an empathy data segment at least five times in the past 12 months. In this example, John Doe may have tweeted angry remarks about his experience with his bank seven times in the past year. This may trigger the outspoken user criteria.

The first and second sets of criteria may be designed to classify a user associated with empathy data segments into the category of extreme user at block 406. Method 400 may classify the user as an extreme user based on which of the criteria in each of the first and second sets of criteria the user met. For example, if the user meets at least half the criteria, he may be classified as an extreme user. If the user meets a specific combination of the criteria, he may be classified as an extreme user. In this example, if the user is an account holder that meets the outspoken user criteria and the digital maven criteria, he may be classified as an extreme user. Because John Doe meets these criteria, the system will classify him as an extreme user. At block 407, method 400 may generate an alert if the user was classified as an extreme user. The alert may be sent to a customer service representative with instructions to contact the user. The alert may be sent directly to the user at a user device with content that invites the user to interact with the financial institution.

It is further noted that the software described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

I claim:

1. A system comprising:
an application programming interface that enables a service provider system to interact with a social media system;
a database associated with the customer service provider system;
an empathy processor that transmits a request for empathy data to the social media system via a network using the application programming interface, wherein the request includes one or more keywords, and receives one or more empathy data segments from the social media system, wherein each of the one or more empathy data segments are associated with a user;
a rules processor that evaluates the one or more empathy data segments based on a plurality of criteria, identifies the respective user associated with each of the one or more empathy data segments, and stores this classification in the database; and
an alert processor associated with the customer service system that generates an alert based on the classification of the user.

2. The system of claim 1, wherein the one or more keywords include empathy keywords and industry keywords.

3. The system of claim 2, wherein the empathy keywords include keywords associated with a negative emotion.

4. The system of claim 2, wherein the empathy keywords include keywords associated with an implicit customer service request.

5. The system of claim 1, wherein to identify the respective user, the rules processor determines an association between a social media username and an account holder of the respective user.

6. The system of claim 1, wherein the rules processor classifies the identified user as an extreme user based on the evaluation of the one or more empathy data segments.

7. The system of claim 1, wherein the database stores account information account holders, and wherein the rules processor retrieves account information about the identified respective user and classifies the identified respective user based on the retrieved account information for the identified respective user.

8. The system of claim 7, wherein the retrieved account information for the identified respective user indicates the amount of online interaction the identified respective user has with the customer service system.

9. The system of claim 7, wherein the retrieved account information for the identified respective user indicates the career path of the identified respective user.

10. The system of claim 7, wherein the retrieved account information for the identified respective user indicates the credit score of the identified respective user.
